(19) United States
(12) Patent Application Publication
(10) Pub. No.: US 2005/0051472 A1
(43) Pub. Date: Mar. 10, 2005

(54) Dialyzer reprocessing system

(76) Inventors: Willie Chionh, Singapore (SG); Foo Chin Jin, Selangor (MY); Pen Lai, Kuala Lumpur (MY); Weng Yew Lee, Teresaville (SG)

Correspondence Address: BIRCH STEWART KOLASCH & BIRCH, PO BOX 747, FALLS CHURCH, VA, 22040-0747, US

(21) Appl. No.: 10/658,375

(22) Filed: Sep. 10, 2003

(51) Int. Cl. B01D 65/02

(52) U.S. Cl. 210/321.69; 210/636; 210/748; 210/646; 210/192

(57) ABSTRACT

An artificial kidney (dialyzer) reprocessing system for washing used artificial kidneys includes a high-pressure water supply system providing RO water and chemical solutions for washing and sterilization so as to make artificial kidney (dialyzers) be reused. The feature of the device is that an ozone water device is connected to an high-pressure water supply system in parallel for providing the artificial kidney (dialyzer) reprocessing device ozone water for washing and sterilization. The problem of chemical residuals in the system can also be avoided.

### BACKGROUND OF THE INVENTION

1. Field of the Invention

The present invention relates to an artificial kidney reprocessing system, especially to a device which not only can efficiently and effectively kill bacterial organisms, but also can avoid the residual chemical solutions in the artificial kidney so that the health of the user will not be jeopardized.

2. Description of the Prior Art

The conventional haemodialysis dialyser reprocessing system, refer to FIG. 5 and FIG. 6, includes a holder 20, a set of high-pressure water supply system 30 disposed in a main body of machine 10. The input end 31 of the high-pressure water supply system 30 ( shown in FIG. 4 ) is connected to the source of the R.O.(reverse osmosis) water and is controlled by a plurality of valves 32a-32e, then is divided into four output connectors 33a-33d. When being used, the connectors 33a, 33b-33d is connected to the connectors for haemodialysis solution 41a, 41b, or connector for blood 42a, 42b for high-pressured reprocessing forward or backward. In addition, the water supply system 30 is parallel connected with a chemical solution supply pipeline 50 which is drawn into by a pump 51 and is controlled by a plurality of valves 52a-52d for processing disinfection and sterilization of artificial kidney 40.

The drawback of the above device is that the disinfection of the artificial kidney depends on the chemical solution. However, the chemical solution is somewhat toxic so that before reuse, the disinfected artificial kidney should be washed again by a large amount of R.O. water or normal saline solution for safety. Thus the dialysis patients won't suffer from hemolysis or poisoning which has bad effect on their health or even lives. There is a need to eliminate the residual chemicals in the artificial kidneys.

### SUMMARY OF THE INVENTION

It is therefore a primary object of the present invention to provide a reprocessing device for artificial kidneys (dialyzer) for safely reuse of the artificial kidney. In order to achieve above object, the present invention provides an artificial kidney reprocessing device with a high-pressure water supply system connected to a ozone water device in parallel so as to provide ozone water, together with RO water, for washing artificial kidney. Or by using the high-concentrated ozone water instead of antiseptic solution during the last sterilization process, the sterilization of the artificial kidney is not only finished quickly but also the problem of residual chemicals in artificial kidney can be avoided.

A further object of the present invention is to provide reprocessing device for artificial kidneys which can also be use as an air cleaning device with ozone and anion. The invention has more applications.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a drawing of lines of a high-pressure water supply system of the present invention;

FIG. 2 is a schematic drawing of a ozone water device of the present invention;

FIG. 3 is another embodiment of the present invention;

FIG. 4 is a pipeline figure of the high-pressure water supply system of the embodiment in FIG. 3.

FIG. 5 is a perspective view of a dialyzer reprocessing system of a prior art;

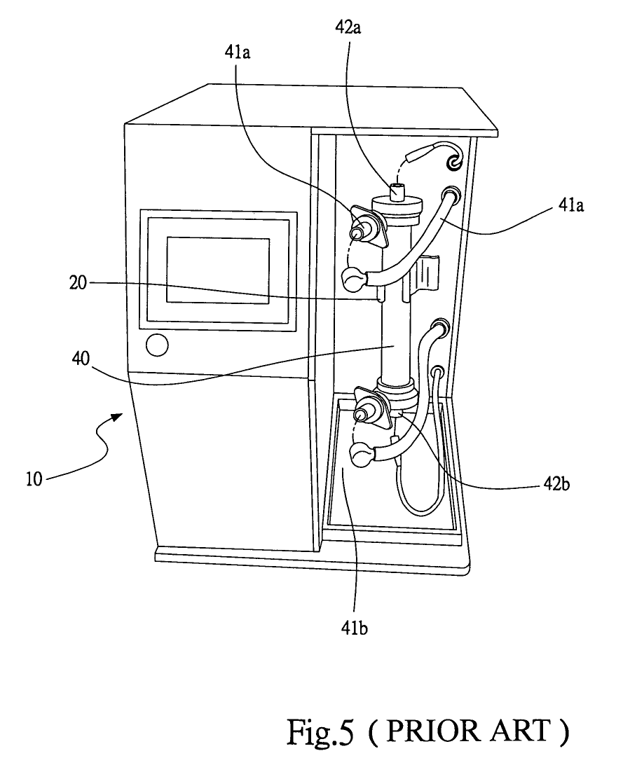

FIG. 6 is a drawing of lines of a high-pressure water supply system of a prior art.

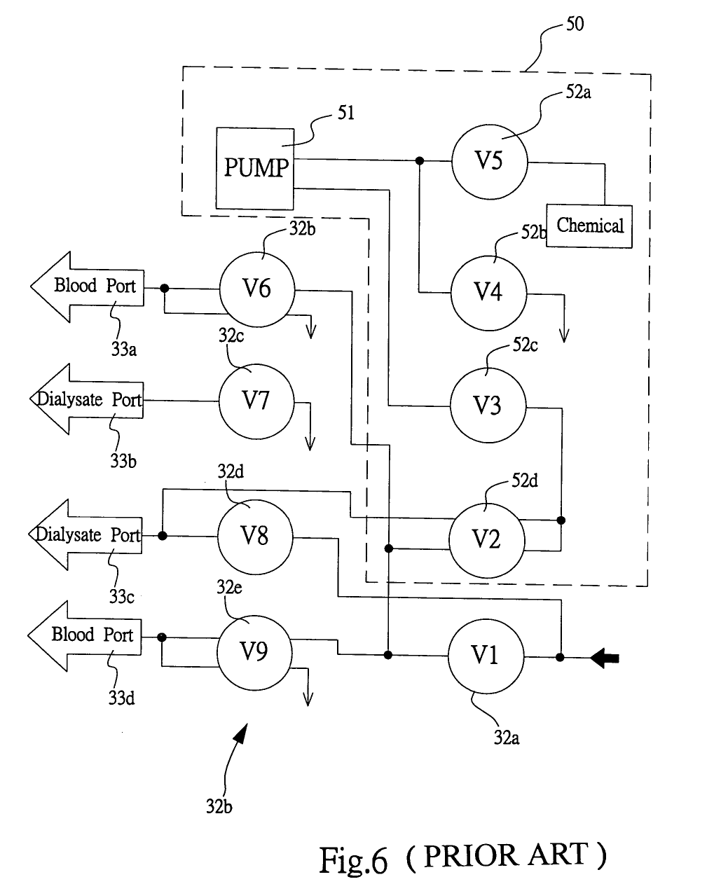

### DETAILED DESCRIPTION OF THE PREFERRED EMBODIMENT

The present invention relates to an artificial kidney reprocessing device for washing artificial kidney ( dialyzer tube ) includes a high-pressure water supply system which provides RO water and chemical solutions to wash and sterilize the artificial kidney forward or backward for reuse of the artificial kidney. The feature of the present invention is in that:

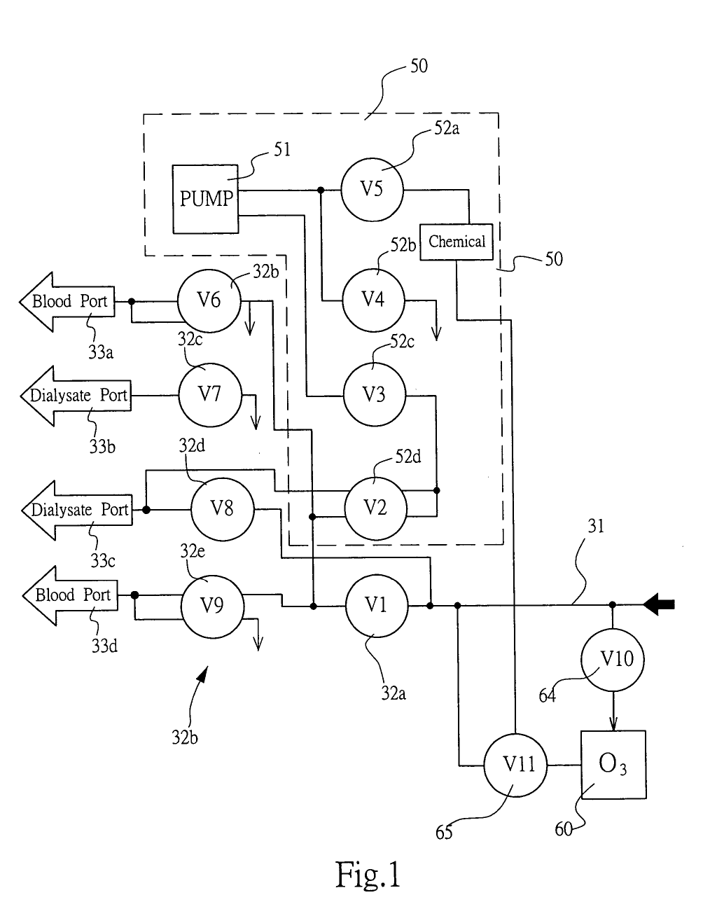

the input end 31 of the high-pressure water supply system 30 (shown in FIG. 1) is connected to an ozone water device 60 in parallel which convert the RO water inside the system 30 into high-concentrated ozone water (O3+H2O).

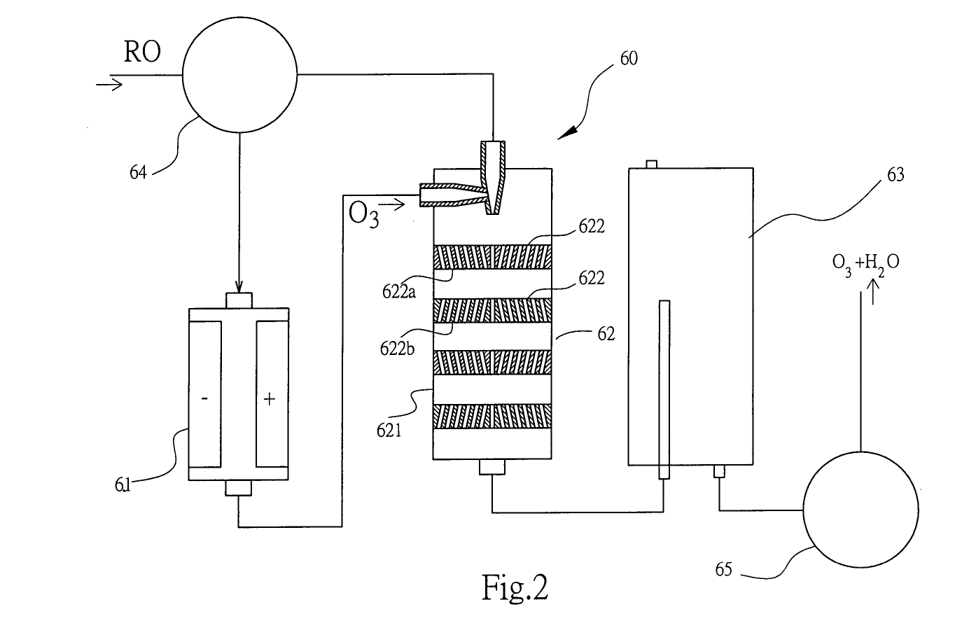

The above mentioned ozone water device 60 (as shown in FIG. 2) is composed of an ozone generator 61, a mixer 62, and a storage tank 63, connected in series. The input end and output end of the ozone water device 60 is connected to valves 64, 65 respectively. The valve 64 is connected to the other end of the input end 31 of the high-pressure water supply system 30 for drafting RO water into the ozone generator 61 so as to produce ozone gas together with water. Then the ozone gas is dissolved into the water inside the mixer 62 until the ozone concentration in water achieves certain degree. The ozone water (O3+H2O) is stored in the storage tank 63. When being used, the ozone water is added from the storage tank 63 into the high-pressure water supply system 30 by the opening of the valve 65 for reprocessing and sterilization of the artificial kidney 40.

The mixer 62 is composed of a barrel 621 and a plurality of baffle 622 with a plurality of small pores 622a, 622b inclined inward or outward respectively. The baffles 622 inclines in different direction are arranged alternatively. Therefore, when the ozone and the water are input concurrently into the inlet of the mixer 62, the arrangement of the baffles 622 can make the time duration of the mixing of the ozone and the water longer, the air bubble of the ozone sparer, thus the ozone concentration of the solution is higher and thus more effective for sterilization.

In accordance with the structure mentioned above, the sterilization effect of ozone is higher than other chemical solutions. Ozone is a kind of highly active material, which is easy to react with other material and thus the oxide is produced. There is nothing to do with the problem of chemical residuals. Ozone can also oxidize chemicals and decompose them into innoxious elements. Therefore, the ozone water produced by the ozone water device 60 can be input together with RO water in the reprocessing procedure of artificial kidneys or be used alone instead of chemical disinfectants in the last step of sterilization so as to finish the sterilization process fast and the problem of chemical residuals inside artificial kidneys after sterilization is also avoided.

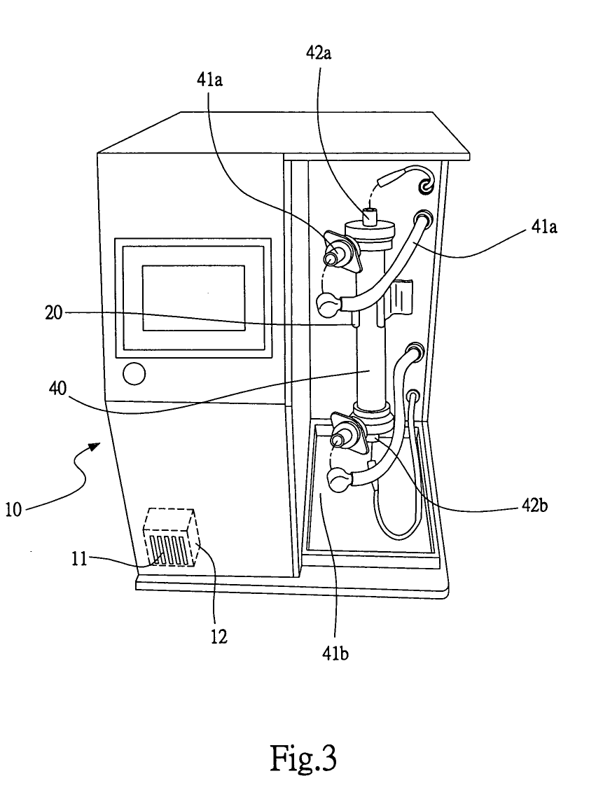

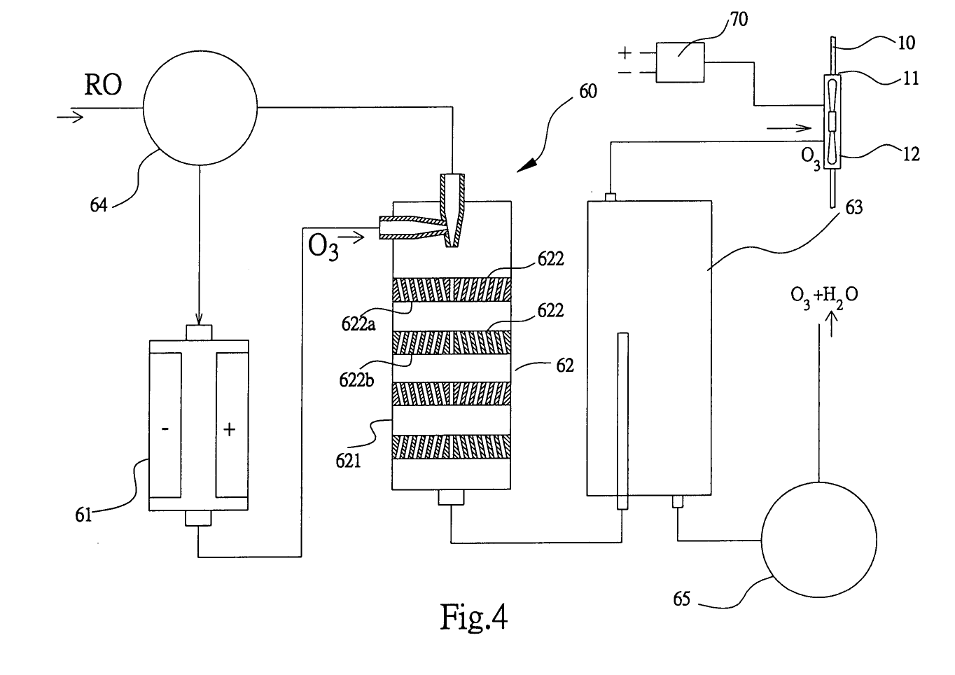

Refer to FIG. 3 & FIG. 4, a vent hole 11 is positioned on the main body of machine 10 with a ventilator 12 disposed therein for exhausting the residual ozone not reacted with water. Or an ozone and anion generator that produces ozone and anion by electrolysis is connected with the ventilator 12 so that the present invention can't only be used as a dialyzer reprocessing system but also is used as an air cleaning device. The two devices are integrated inside one machine.

It should be noted that the above description and accompanying drawings are only used to illustrate some embodiments of the present invention, not intended to limit the scope thereof. Any modification of the embodiments should fall within the scope of the present invention.

1. An artificial kidney (dialyzer) reprocessing device for washing used artificial kidneys comprising
a high-pressure water supply system providing RO water and chemical solutions for washing and sterilization so as to make dialyzers be reused; the characteristic of the device is that:
an ozone water device connected to an input end of said high-pressure water supply system in parallel, said ozone water device convert RO water into high concentration ozone water for the use of said artificial kidney (dialyzer) reprocessing device.

2. The artificial kidney (dialyzer) reprocessing device as claimed in claim 1, wherein said ozone water device comprising an ozone generator, a mixer, and a storage tank, connected in series; an input end and output end of said ozone water device is connected to a valve respectively; said valve is connected to an input end of said high-pressure water supply system for drafting RO water into said ozone generator so as to produce ozone gas together with water; then the ozone gas is dissolved into water inside said mixer until the ozone concentration in water achieves certain degree and the ozone water (O3+H2O) is stored in said storage tank.

3. The artificial kidney (dialyzer) reprocessing device as claimed in claim 2, wherein said mixer having a barrel and a plurality of baffle with a plurality of small pores, inclined inward or outward respectively, said baffles inclines in different direction are arranged alternatively.

4. The artificial kidney (dialyzer) reprocessing device as claimed in claim I, wherein a vent hole is arranged on a main body of machine with a ventilator disposed therein for exhausting the residual ozone not reacted with water.

5. The artificial kidney (dialyzer) reprocessing device as claimed in claim 1, wherein a vent hole is arranged on the machine with a ventilator disposed therein while an ozone and anion generator that produces ozone and anion by electrolysis is integrated into the dialysis device, connected with the ventilator.
